(19) United States
(12) Patent Application Publication
(10) Pub. No.: US 2009/0053361 A1
(43) Pub. Date: Feb. 26, 2009

(54) OLIVE POMACE VINEGAR

(76) Inventor: Gregory Pipko, Katzrin (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/282,370

(22) PCT Filed: Mar. 14, 2007
(86) PCT No.: PCT/IL2007/000328

§ 371 Date: Sep. 10, 2008

(30) Foreign Application Priority Data
Mar. 15, 2006 (IL) 074320

(51) Int. Cl. C12J 1/00

(52) U.S. Cl. 426/17; 426/61

(57) ABSTRACT

The present invention discloses olive pomace vinegar, wherein the pomace is obtained during the olive oil processing. The invention also discloses a method for producing olive pomace vinegar comprising admixing olive pomace, water, carbohydrate source and fermenting microorganisms.

### FIELD OF THE INVENTION

The present invention generally relates to olive pomace vinegar and to methods of production of the same.

### BACKGROUND OF THE INVENTION

Vinegar is a sour-tasting liquid made from the oxidation of ethanol in wine, cider, beer, fermented fruit juice, or nearly any other liquid containing alcohol. It can also be made by certain bacteria operating on sugar-water solutions directly, without intermediary conversion to ethanol.

Vinegar is a dilute form of acetic acid, ranging typically from three to five percent by volume for table vinegar and higher concentrations for pickling. Natural vinegars also contain smaller amounts of tartaric acid, citric acid, and other acids. The oxidation is carried out by acetic acid bacteria, as was shown in 1864 by Louis Pasteur. Modern systems work with vinegar bacteria at the liquid and bringing the air into the vinegar with a venturi pump system or with a turbine. These systems have a production time between 38 hours and 3 days to get the ready vinegar.

Wine vinegar is usually made from red or white wine, and is the most commonly used vinegar in Germany and other European countries. Apple cider vinegar is made from cider or apple must, and is often sold unfiltered, with a brownish-yellow color. Fruit vinegars are made from fruit wines without any additional flavoring. Balsamic vinegar is an aromatic, aged type of vinegar manufactured in Modena, Italy. Common flavors of fruit vinegar include black currant, raspberry, and quince. Typically, the flavors of the original fruits remain tasteable in the final vinegar. The Japanese prefer rice vinegar and use it for much the same purposes as Europeans, as well as for sushi rice, in which it is an essential ingredient. Coconut vinegar, made from the sap of the coconut palm, is used extensively in Southeast Asian cuisine, as well as in some cuisines of India. Vinegar made from raisins is used in cuisines of the Middle East, and is produced in Turkey. Cane vinegar, made from sugar cane juice, is most popular in the Philippines, although it is also produced in France and the United States. Vinegar made from beer is produced in Germany, Austria, and the Netherlands. Vinegar made from honey is rare, though commercially available honey vinegars are produced in Italy and France. Chinese black vinegar is an aged product made from rice, wheat, millet, or sorghum. Herb vinegars are flavored with herbs, most commonly Mediterranean herbs such as thyme or oregano. An East Asian variety of flavored vinegar known as sweetened vinegar is made from rice wine and herbs including ginger, cloves and other spices.

Olive Husk or Pomace is often sent to reprocessors who use steam and solvents to remove more oil (pomace oil). Sometimes the pits are removed from the pomace first. The left-over fibrous material is primary lignin and cellulose and has a high BTU content. It can be composted or burned. In California, the ripe olive industry burns pits to produce heat for processing needs. In Italy, some of the frantoios are heated by burning olive pits in what resembles a pellet stove. The pits can also be burned to produce heat to help with the malaxation process in cold climates. 2 phase decanter centrifuges produce a watery husk. The watery husk is considered less of a disposal problem than the olive water produced in a 3 phase decanter. It can be spread back on the field, trucked to landfill or is occasionally dried onsite in commercially available dryers.

GB Pat No 367751 discloses an improved process for utilizing oil seed cakes by obtaining a starchy material in the residue which is saccharified by the action of enzymes or by heating in autoclaves with weak acids, the sugar substances are extracted by diffusion.

GB Pat No 565772 presents a production of organic acids by fermentation. For fermenting cellulose, hemicellulose, starch and their hydrolytic degradation products to obtain fatty acids, alcohols and ketones, a culture is used which is obtained by growing together: mixed bacteria obtained from soil or from the intestinal canals of herbivorous animals or both, without any separation or selective cultivation, and a pure culture chosen according to the products desired from cultures of lactic, butyric, pseudo - lactic, cellulosolytic or pectinolytic bacteria.

CN Pat No. 1584007 introduces a kind of olive vinegar and its producing method and equipment. It contains fresh olive juice, residue of olive wine, rice, bran putamina, olive branch and leave powder, acetic acid fungus, dry barn for brewing wine, and distilled water. The producing method is: first, cultivate rice, parts of bran putamina, water and acetic acid fungus to acetic acid, and then put fresh olive juice into the jar for aceifying after sterilization. Thirdly, put residue of olive wine, olive branch and leave powder, the rest of bran putamina and the forgoing compound into the jar for acetic acid fermentation, and insert air into the center of jar, holding a certain distance. At the same time, pour the vinegar time and again. Finally, stop ferment when acidity does not rise any longer after 20-30 days and then marinate with common salt and warm water for 5-8 days to meet the acidity. At least, sterilize and enclose. In short, the invention has thick olive vinegar's smell and good taste. Moreover, it has the function of health care.

A cost-effective quality and tasty vinegar, with improved organoleptic properties is not commercially available yet. Vinegar has been used since ancient times, and is an important element in Western, Asian, and other traditional cuisines of the world. Most people are interested in the fine taste of best vinegar, and the wide range he can be used as spice for dishes, especially for salads and refined dressings. Special vinegars can offer new tastes. Therefore, olive pomace vinegar made from inexpensive material meets a long felt need.

### SUMMARY OF THE INVENTION

It is thus one object of the present invention to provide olive pomace vinegar, wherein the pomace is obtained during the olive oil processing.

It is according to one embodiment of the present invention wherein the olive pomace vinegar further comprising ingredients selected in a non-limiting manner from olive pomace, water, carbohydrate source and fermenting microorganisms.

It is according to another embodiment of the present invention wherein the fermenting microorganisms are Saccharomyces cerevisiae or other beer yeasts. The concentration of the fermented microorganisms is preferably from 2 to 6 grams per liter, especially 4 g/L.

It is according to another embodiment of the present invention wherein the carbohydrate source is selected from glucose, fructose or sucrose.

It is according to another embodiment of the present invention wherein the color of the vinegar is yellow.

It is according to another embodiment of the present invention wherein the color of the vinegar is brown.

It is according to another embodiment of the present invention wherein the test of the vinegar is characterized with Balsam vinegar known test.

It is according to another embodiment of the present invention wherein the pH of the vinegar lies in the range of about 1.5 to 4.5, especially from about 2 to about 3.

It is according to another embodiment of the present invention wherein the product additionally comprising polyphenols.

It is according to another embodiment of the present invention wherein by fermentation the entire quantity of carbohydrate source is converted into alcohol.

It is according to another embodiment of the present invention wherein the product additionally comprising preservatives.

It is according to another embodiment of the present invention wherein the preservatives are etheric oils.

It is according to another embodiment of the present invention wherein the preservatives are selected from biocides, bactericides or fungicides.

It is according to another embodiment of the present invention wherein the etheric oils are obtained from fruits or vegetables selected from linen blossoms, St. Johns wort oil, calendula, arnica, sage, niseseed, carnation oil, chamomile, peppermint oil, caraway seed , larch , Juniper, rosemary, eucalyptus oil, lavender, fir needle oil, bergamot oil, citrus oil, lemon balm, marjoram, thyme, basil and fennel.

It is according to another embodiment of the present invention wherein the preservatives are selected from methyl- and/or propyl-paraben.

It is according to another embodiment of the present invention wherein the concentration of etheric oils ranges from about 0.01 to 5.0% (weight percent).

It is according to another embodiment of the present invention wherein the product additionally comprising additives, said additives are selected from a group including perfuming agents, olive oil, olive-born pomace, olives or parts thereof, stabilizers, thickfires, emulsifiers, vitamins, radical scavengers, conditioners, antioxidants, lipophilic or hydrophilic plant extracts or any combination thereof.

Another object of the invention is to provide a cost effective method for producing olive pomace vinegar comprising; admixing olive pomace, water, carbohydrate source and fermenting microorganisms; obtaining an aerobic fermentation during about 7 to 14 days; suspending the obtained solution during about a month and/or a month and a half; separating the liquids from the solid suspension, e.g., the cake; and, possibly recycling said cake in another cycle of said method. The olive pomace vinegar provided in this method is as defined in any of the above.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention.

Various modifications, however, will remain apparent to those skilled in the art, since the generic principles of the present invention have been defined specifically to provide a cost-effective quality and tasty vinegar, with improved organoleptic properties. Olive pomace, residue from the press of olive oil, is an inexpensive material, and by utilizing it no environmental nuisance is caused.

The olive pomace, which is organic material, contains about 4% of oil not including seeds oil. Olive pomace is also a high content source of Polyphenols. The polyphenols are a group of plant chemical substances; they are responsible for the coloring of some plants, for autumn leaf color. Polyphenols have been shown to be strong antioxidants with potential health benefits.

In order to classify olive oil by taste, it is subjectively judged by a panel of professional tasters in a blind taste test. This is also called its organoleptic quality. The olive pomace vinegar has improved organoleptic property.

The term ‘yeast’ broadly refers hereinafter to any single-celled microorganisms and especially adapted for vinegar production via anaerobic or aerobic fermentation; and more specifically to commercially available strains of bakers yeasts, i.e., vinegar producing Saccharomyces cerevisiae.

The term ‘about’ refers hereinafter to a tolerance of ±20% of the defined measurement. Olive pomace vinegar was prepared as follows: 15% (W/W) of sugar was dissolved in water with 60% (W/W) olive pomace and with 0.4 to 1% (W/W) of commercially available Saccharomyces cerevisiae. After full dissolution, the broth was aerobically fermented for 10 days. Afterwards, the suspension was aged for about 30 to 45 days. The liquid pomace vinegar was separated from the solid. The pH of the vinegar was in the range of about 4 to 6. A good smelling product was organolepicaly asset to be characterized with unique Balsam-like qualities. Optionally, the cake being separated from the suspension was utilized for at least one other fermentation.

Olive vinegar made from waste product of olive oil can also be produce. Vegetable oil, as such as olive oil, is produced by pressing it out of oil-bearing seeds, usually by hydraulic power presses. The waste product is a dense slab or ‘cake’ of crushed and compressed seed husks. This dense slab is provided in some extant for animal feed wherein most of it is decomposed or regarded as costless agricultural effluent. Once the olives have been ground into a paste and mixed in the malaxation tanks, the paste is separated into three components; vegetable water, oil and the husk. The husk (pomace) contains the skins, pulp and pit fragments. This separation is most commonly achieved via a horizontal decanter centrifuge or an olive oil press.

It is according to another embodiment of the present invention wherein the preservatives are selected from biocides, bactericides or fungicides. The preservatives may comprise etheric oils. The etheric oils are preferably but not exclusively obtained form fruits or vegetables selected from linen blossoms (etheric oils with quercitin and farnesol) St. Johns wort oil (for example, olive oil extracts) calendula, arnica (for example oily extracts of blossoms with etheric oils, polar extracts with flavonoid lemon balm (for example flavone and etheric oils), sage (for example etheric oils with thymol) niseseed (etheric oils with trans-anethol), carnation oil (for example etheric oil with eugenol), chamomile (camazulene, alpha-bisabolol, myrtols, (limonine, alpha-pinene, cineol), peppermint oil (for example, oil with menthol) caraway seed (for example, oil with carvone) larch (for example oil with alpha-pinene) Juniper, rosemarin, eucalyptus oil, lavender, fir needle oil, bergamot oil, citrus oil, lemon balm, marjoram, thyme, basil (stomatica or herbs) and fennel.

It is according to another embodiment of the present invention wherein the preservatives are selected from methyl- and/or propyl-paraben.

It is well in the scope of the present invention wherein the etheric oils are obtained from fruits and vegetables selected from sage, Rosemarie, lemon ,bergamot, tea tree, mint, pine, sandalwood, patchouli, lemon grass, peppermint, grapefruit, oridanium, manuka, eucalyptus, geranium, clove, cinnamon, Melissa or a combination thereof. The concentration of etheric oils is preferably ranging from about 0.1 to 5.0% (weight percent).

The additives are preferably, yet not exclusively, selected from perfuming agents, stabilizers, thickfires, emulsifiers, vitamins, radical scavengers, conditioners, antioxidants, lipophilic or hydrophilic plant extracts or any combination thereof.

1. Olive pomace vinegar, wherein the pomace is obtained during the olive oil processing.

2. The olive pomace vinegar according to claim 1, comprising olive pomace, water, carbohydrate source and fermenting microorganisms.

3. The olive pomace vinegar according to claim 1, wherein the fermenting microorganisms are Saccharomyces cerevisiae or other beer yeasts, especially 4 gr per liter.

4. The olive pomace vinegar according to claim 1, wherein the carbohydrate source is selected from glucose, fructose or sucrose.

5. The olive pomace vinegar according to claim 1, wherein the color of the vinegar is yellow.

6. The olive pomace vinegar according to claim 1, wherein the color of the vinegar is brown.

7. The olive pomace vinegar according to claim 1, wherein the test of the vinegar is characterized with Balsam vinegar known test.

8. The olive pomace vinegar according to claim 1, wherein the pH of the vinegar lies in the range of about 2 to 3.

9. The olive pomace vinegar according to claim 1, additionally comprising polyphenols.

10. The olive pomace vinegar according to claim 1, wherein by fermentation the entire quantity of carbohydrate source is converted into alcohol.

11. The olive pomace vinegar according to claim 1, additionally comprising preservatives.

12. The olive pomace vinegar according to claim 11, wherein the preservatives are etheric oils.

13. The olive pomace vinegar according to claim 11, wherein the preservatives are selected from biocides, bactericides or fungicides.

14. The olive pomace vinegar according to claim 12, wherein etheric oils are obtained form fruits or vegetables selected from linen blossoms, St. Johns wort oil, calendula, arnica , sage , niseseed, carnation oil, chamomile, peppermint oil, caraway seed , larch , Juniper, rosemary, eucalyptus oil, lavender, fir needle oil, bergamot oil, citrus oil, lemon balm, marjoram, thyme, basil and fennel.

15. The olive pomace vinegar according to claim 11, wherein the preservatives are selected from methyl- and/or propyl-paraben.

16. The olive pomace vinegar according to claim 12, wherein the concentration of etheric oils is ranging from about 0.01 to 5.0% (weight percent).

17. The olive pomace vinegar according to claim 1, additionally comprising additives, said additives are selected from a group including perfuming agents, olive oil, olive-born pomace, olives or parts thereof, stabilizers, thickfires, emulsifiers, vitamins, radical scavengers, conditioners, antioxidants, lipophilic or hydrophilic plant extracts or any combination thereof.

18. A method for producing olive pomace vinegar comprising;
a. admixing olive pomace, water, carbohydrate source and fermenting microorganisms
b. obtaining an aerobic fermentation during about 7 to 14 days;
c. suspending the obtained solution during about a month and/or a month and a half; and,
d. separating the liquids from the solid suspension, e.g., the cake; and,
e. possibly recycling said cake in another cycle of said method.

19. The method for obtaining olive pomace vinegar according to claim 18, wherein the pomace is obtained during the oil process.

20. The method for obtaining olive pomace vinegar according to claim 18, comprising fermenting microorganisms selected from Saccharomyces cerevisiae or other beer yeasts.

21. The method for obtaining olive pomace vinegar according to claim 18, wherein the carbohydrate source is selected from glucose, fructose or sucrose.

22. The method for obtaining olive pomace vinegar according to claim 18, wherein the color of the vinegar is yellow.

23. The method for obtaining olive pomace vinegar according to claim 18, wherein the color of the vinegar is brown.

24. The method for obtaining olive pomace vinegar according to claim 18, wherein the test of the vinegar is characterized with Balsam vinegar known test.

25. The method for obtaining olive pomace vinegar according to claim 18, wherein the pH of the vinegar lies in the range of about 2 to 3.

26. The method for obtaining olive pomace vinegar according to claim 18, additionally comprising admixing polyphenols.

27. The method for obtaining olive pomace vinegar according to claim 18, comprising fermenting the entire quantity of carbohydrate source into alcohol.

28. The method for obtaining olive pomace vinegar according to claim 18, additionally comprising admixing preservatives.

29. The method for obtaining olive pomace vinegar according to claim 28, wherein the preservatives are etheric oils.

30. The method for obtaining olive pomace vinegar according to claim 28, wherein the preservatives are selected from biocides, bactericides or fungicides.

31. The method for obtaining olive pomace vinegar according to claim 29, wherein etheric oils are obtained form fruits or vegetables selected from linen blossoms, St. Johns wort oil, calendula, arnica , sage , niseseed, carnation oil, chamomile, peppermint oil, caraway seed, larch, Juniper, rosemary, eucalyptus oil, lavender, fir needle oil, bergamot oil, citrus oil, lemon balm, marjoram, thyme, basil and fennel.

32. The method for obtaining olive pomace vinegar according to claim 28, wherein the preservatives are selected from methyl- and/or propyl-paraben.

33. The method for obtaining olive pomace vinegar according to claim 29, wherein the concentration of etheric oils is ranging from about 0.01 to 5.0% (weight percent).

34. The method for obtaining olive pomace vinegar according to claim 18, additionally comprising admixing additives, said additives are selected from a group including perfuming agents, stabilizers, thickfires, emulsifiers, vitamins, radical scavengers, conditioners, antioxidants, lipophilic or hydrophilic plant extracts or any combination thereof.
